(19) United States
(12) Patent Application Publication
(10) Pub. No.: US 2010/0010886 A1
(43) Pub. Date: Jan. 14, 2010

(54) SYSTEM AND METHOD FOR FACILITATING AND ENCOURAGING CHARITABLE GIVING

(76) Inventor: Michael J. Flynn, JR., Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/501,234

(22) Filed: Jul. 10, 2009

Related U.S. Application Data
(60) Provisional application No. 61/079,750, filed on Jul. 10, 2008.

(51) Int. Cl. G06Q 40/00; G06Q 30/00; G06Q 20/00; H04W 4/00

(52) U.S. Cl. 705/14.15; 705/39; 705/44; 705/34; 455/466

(57) ABSTRACT

A system and method for facilitating and encouraging micro-donations is described. A donation facilitator serves as a centralized system for providing promotion, banking, and donation acceptance for non-profit organizations of all sizes. One embodiment accepts donations from donors via mobile devices such as smartphones. The embodiment also allows the donors to submit multimedia files such as pictures along with their donation, which are then combined into a group image that is displayed on a large-format video screen, such as a video screen at a concert or sporting event.

### CROSS-REFERENCE TO RELATED APPLICATION

This application claims the benefit of U.S. Provisional Patent Application No. 61/079750, filed Jul. 10, 2008, which is hereby incorporated by reference in its entirety.

### BACKGROUND

Many nonprofit organizations, or “NPOs,” improve society by providing help and support to those in need. However, individual NPOs are often small entities that do not have the resources to engage in large-scale fundraising or advertising efforts, to accept contributions in multiple different ways, or to obtain other benefits available to large organizations such as the Red Cross, the Salvation Army, and the like. Further, the fundraising potential of collecting small donations, or “micro-donations,” from large numbers of donors has proven to be tremendously effective, but the infrastructure required to encourage and collect micro-donations on a scale that would make it worthwhile has not been available to most organizations. What is needed is a system that allows NPOs of all sizes to share in the benefits inherent in large organizations.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments of the present disclosure are intended to solve many of the problems discussed above. Some embodiments of the systems and methods disclosed herein provide benefits of scale to all types of NPOs by funneling donations from multiple donors and to multiple NPOs through a single donation facilitation system, thereby aggregating stored funds and allowing greater returns for the donations and investments of individual NPOs than otherwise possible. Also, some embodiments of the systems and methods disclosed herein provide infrastructure for encouraging and rewarding micro-donations. In one embodiment, micro-donations are accepted from mobile devices used by attendees at a large event such as a concert or sporting event. Such donations are encouraged and rewarded by displaying pictures, videos, or graphics uploaded from the mobile devices or scraped from a web page on a large-format video screen at the venue.

A system for encouraging and facilitating donations is provided. The system comprises a profile data store; an account management front end server configured to enable creation of accounts and to store account data within the profile data store; a donation front end server configured to receive donations associated with accounts and one or more multimedia files associated with each donation; and a presentation server configured to generate multimedia output based on the one or more multimedia files associated with each donation.

In other embodiments, a method of accepting a donation and rewarding a donor is provided. The method comprises, under the control of instructions executed by one or more processors of a computer system: transmitting an indication that causes a prompt to be presented, wherein the prompt instructs one or more potential donors to submit a donation; receiving a donation notification and an associated multimedia file from a donor; generating a reward multimedia presentation including at least the associated multimedia file from the donor; and presenting the reward multimedia presentation to the donor.

In other embodiments, a computer-implemented method of creating an account at a donation facilitation system is provided. The method comprises receiving, by an account management front end server, a notification from a point of sale that a potential donor has consented to creation of an account, wherein the notification includes billing information and personal information associated with the potential donor that were entered as part of the point of sale transaction; storing the personal information and the billing information in a profile data store; establishing login information associated with the potential donor; and transmitting the login information to the potential donor via the point of sale.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates high-level aspects of a system and method for encouraging micro-donations through a centralized donation facilitator according to various embodiments of the present disclosure;

FIG. 2 is a block diagram illustrating an overview of a donation facilitation system according to various embodiments of the present disclosure;

FIG. 3 is a block diagram illustrating some ways in which the donation facilitation system shown in FIG. 2 can help NPOs of all sizes experience benefits of scale;

FIG. 4 is a block diagram illustrating an overview of a Unity Fund according to various embodiments of the present disclosure;

FIG. 5 is a block diagram illustrating a donation facilitator according to various embodiments of the present disclosure;

FIG. 6 is a block diagram illustrating selected components of a system for allowing a potential donor to open an account at the donation facilitator of FIG. 5 via a point of sale;

FIG. 7 is a block diagram illustrating selected components of a system for allowing a donor who has established an account at the donation facilitator of FIG. 5 to add funds to their account via an SMS message;

FIG. 8 illustrates a method for creating a donation facilitation account via a web page according to various embodiments of the present disclosure;

FIG. 9 illustrates a method for creating a donation facilitation account via a point of sale according to various embodiments of the present disclosure;

FIG. 10 illustrates a method of accepting a donation facilitation account contribution from a mobile phone according to various embodiments of the present disclosure;

FIG. 11 illustrates a method of designating a donation to a recipient and rewarding a donor according to various embodiments of the present disclosure;

FIG. 12 illustrates aspects of an image generated by the donation facilitator of FIG. 5;

FIG. 13 is a block diagram illustrating a system for displaying a master image generated by the donation facilitator of FIG. 5 on a large-format video screen; and

FIG. 14 illustrates aspects of social networking features of the donation facilitator of FIG. 5.

### DETAILED DESCRIPTION

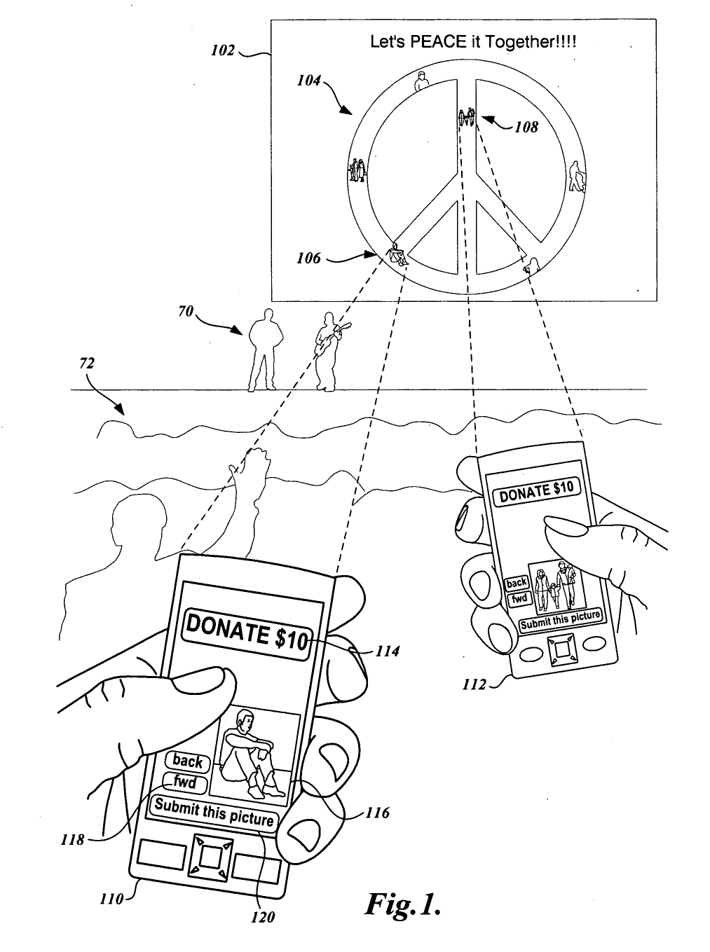

FIG. 1 illustrates high-level aspects of an exemplary system and method for encouraging micro-donations through a centralized donation facilitator. In this embodiment, a band 70 is trying to encourage fans 72 attending their concert to donate to one of their favorite causes. During a break between songs, the band 70 can cause an image 104 to be displayed on a large format video screen 102 at the concert venue. The band 70 can then announce to the fans 72 that they should donate to an NPO that is important to the band 70, and instruct the fans 72 how to donate with their mobile devices 110, 112.

As illustrated in FIG. 1, mobile device 110 and mobile device 112 are smart phones running an application or viewing a web site tailored to the donation facilitation system. Mobile device 110 and mobile device 112 need not be smart phones, but could instead be any model of phone having a camera and capable of supporting Multimedia Messaging Service (MMS) messaging. Donating is made easy, and a simple interface button 114 can be used to send the donation. The donor can also use navigation interface buttons 118 to navigate multimedia files on the mobile device, and press an submission interface button 120 to cause a selected multimedia file 116 to be sent to the donation facilitator along with their donation. The donation facilitator causes the multimedia files submitted by mobile devices 110, 112 to be added 106, 108 to the image 104, along with images from other donors, to fill in a pattern in the image 104 that represents the NPO. Corresponding images are also added to a global collage representing all giving that takes place through the donation facilitation system (not pictured).

Though significant processing takes place between the pressing of the donation button 120 and the multimedia file 106 appearing on the large format video screen 102, the system is intended to give the donor the impression that the multimedia file 106 is sent directly “to” the video screen 102. This real-time creation of a group image is intended to give donors a reward for donating, and to encourage other potential donors to want to participate and see their own multimedia files appear in front of the crowd. Further rewards, such as commemorative posters, screensavers, wallpapers, or ringtones may also be provided to donors who donated at least a predetermined amount.

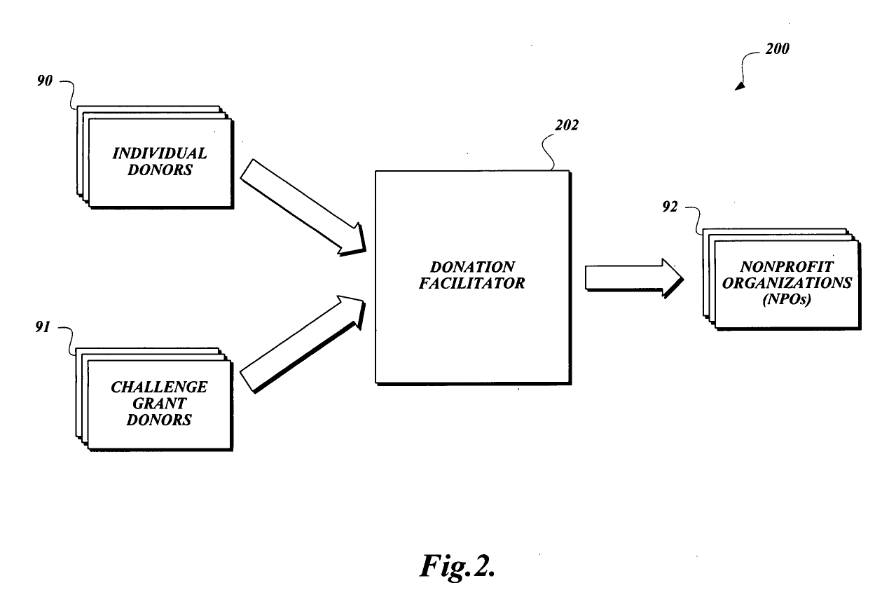

FIG. 2 is a block diagram showing a high-level overview of an exemplary donation facilitation system 200. The donation facilitation system 200 serves to transfer information and funds from donors such as individual donors 90 and challenge grant donors 91 to NPOs 92. More specifically, initially NPOs 92 create an account with a donation facilitator 202, as do individual donors 90 and challenge grant donors 91. Thereafter, each such NPO 92 is able to accept donations from and advertise to potential donors. The donation facilitator 202 is capable of accepting accounts and donations from a wide variety of different types of potential donors. In this regard, individual donors 90 should be construed as individuals, collections of individuals, and small or large organizations whose contributions will be directly assigned to an NPO 92. Challenge grant donors 91 include wealthy individuals as well as organizations (including foundations) that often donate large amounts. Donations from challenge grant donors 91 become actual donations when matched by contributions from other donors, at which time the donation from the challenge grant donors 91 and the matching contributions are assigned to the receiving NPO 92.

As shown in FIG. 2, donations from individual donors 90 and challenge grant donors 91 are funneled through the centralized donation facilitator 202. This centralization of donation flow through a single entity has many benefits. One such benefit is that, no matter their size, NPOs 92 taking part in the system can obtain scale and donation infrastructure benefits that may otherwise be unavailable to them. Another benefit of centralization is that it improves the confidence and security of individual donors 90 and challenge grant donors 91 by providing a single, trusted entity to handle financial transactions, even when the eventual recipient of the funds may be an obscure NPO to which the donor has not previously donated. In addition, this type of centralization has the benefit of providing increased transparency and real-time accountability to the fundraising activities of NPOs. Reports of fundraising activity may be more easily audited and reported to the public from the centralized system, which can provide market forces to drive the NPO sector to be more efficient and productive. Further, access to such a system can also provide greater financial stability and fluidity to NPOs, allowing them to focus more on providing social value and less on generating profit in order to support a cumbersome infrastructure for their own group alone.

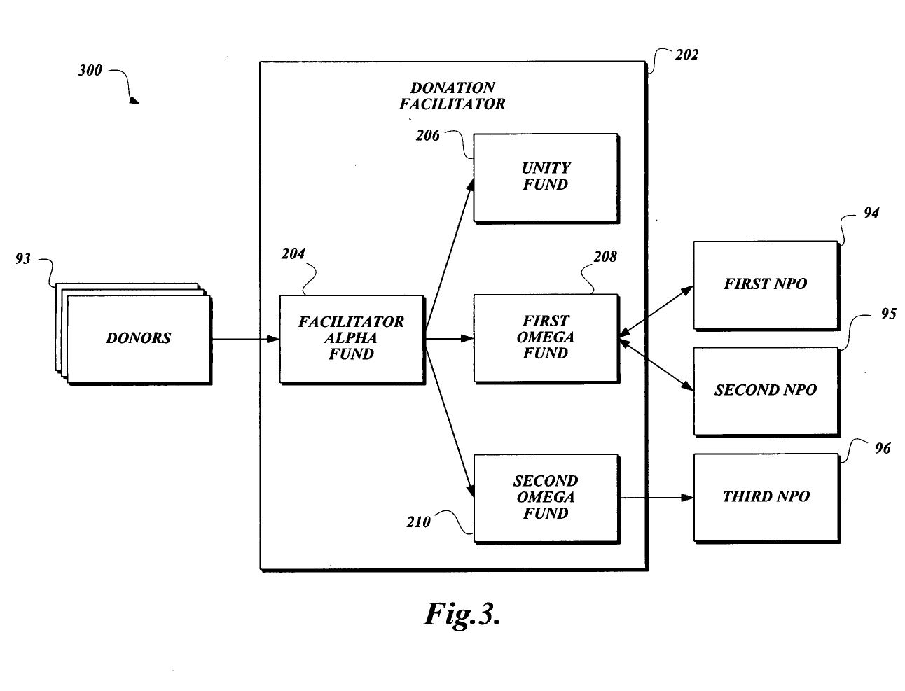

FIG. 3 illustrates some of the ways in which embodiments of the donation facilitator 202 can help NPOs of all sizes experience benefits of scale normally accessible to only large entities. Embodiments of the donation facilitator 202 can be used to structure investment opportunities for NPOs in ways typically only available to investment banks. Donors 93, including individual donors 90 and challenge grant donors 91 (FIG. 2), make financial contributions to an account of the donation facilitator 202. The contributions are held in a facilitator alpha fund 204. The facilitator alpha fund 204 invests the contributions from donors 93 in securities and other types of accounts that provide a return on investment, such as a mutual fund. The contributions are held in the facilitator alpha fund 204 for a certain amount of time intended to generate growth. The amount of time may be determined in multiple ways. For example, the facilitator alpha fund 204 may hold onto contributions for a specific, predetermined period of time before making them available to their eventual recipients. Or, contributions from an individual donor 90 may initially be placed in the facilitator alpha fund 204 until the individual donor 90 selects an NPO 92 to receive a portion of the contribution. As yet another example, a contribution from a challenge grant donor 91 may be held in the facilitator alpha fund 204 until other contributions sufficient to satisfy the terms of the challenge grant are made, at which time the contribution associated with the challenge grant is transferred to the designated NPO 92.

Funds may be transferred from the facilitator alpha fund 204 to a target NPO in multiple ways. In one embodiment, the funds may be directly transferred from the facilitator alpha fund 204 to an account of the NPO at a third party financial institution. In another embodiment (and as illustrated in FIG. 3), the funds may be transferred from the facilitator alpha fund 204 to an omega fund within the donation facilitator 202. The omega funds are similar to accounts within other financial institutions, but may provide additional benefits to NPOs who choose to keep their funds within the donation facilitator 202. For example, if the donation facilitator 202 is itself a nonprofit organization or a not-for-profit organization, the donation facilitator 202 may be able to provide a better rate of return or lower fees with regard to assets stored in omega funds than if the assets are stored in a for-profit financial institution.

One example of an omega fund is first omega fund 208. First omega fund 208 is used by a first NPO 94 as if it were a traditional investment account. The first NPO 94 may withdraw funds from first omega fund 208 to provide services and pay for operating costs. The first NPO 94 may also deposit funds into the first omega fund 208 to obtain the low cost investment and banking benefits that the donation facilitator 202 is able to provide. The first omega fund 208 may also operate like a mutual fund, in that multiple NPOs may invest in the same omega fund to obtain better returns on the resulting larger, combined principal balance. In this regard, FIG. 3 illustrates a second NPO 95 that also deposits and withdraws funds from first omega fund 208 to obtain the just described benefits. Of course, first omega fund 208 also receives contributions from donors 93 via the facilitator alpha fund 204, as well as deposits from the NPOs.

Another simpler example of an omega fund is second omega fund 210. The second omega fund 210 is primarily set up to receive donations from the facilitator alpha fund 204 that are designated for a given NPO, such as third NPO 96. While the second omega fund 210 will probably not be able to provide the same economies of scale as a combined fund such as the first omega fund 208 that is shared between multiple NPOs, the second omega fund 210 may provide a simpler type of account for an NPO that merely wishes to use the donation facilitator 202 for its donation processing and advertising features instead of for its investment features. The second omega fund 210 is simplified because it merely allows the third NPO 96 to withdraw donated funds once they are available.

As is standard, the donation facilitator 202 may reserve a percentage of each transaction to pay for operating costs, transaction costs, or for other reasons. For example, the donation facilitator 202 may keep a portion of each transfer of funds between the multiple donors 93 shown in FIG. 3 and the facilitator alpha fund 204, or a portion of each transfer of funds between the facilitator alpha fund 204 and the various omega funds 208, 210. As another example, the donation facilitator 202 may keep a portion of the income generated by the facilitator alpha fund 204, either in addition to or instead of keeping a portion of individual transactions. While the retained funds may be used to pay for operating costs, they may also serve other purposes. In one embodiment, a portion of the funds retained by the donation facilitator 202 are deposited in a Unity Fund 206.

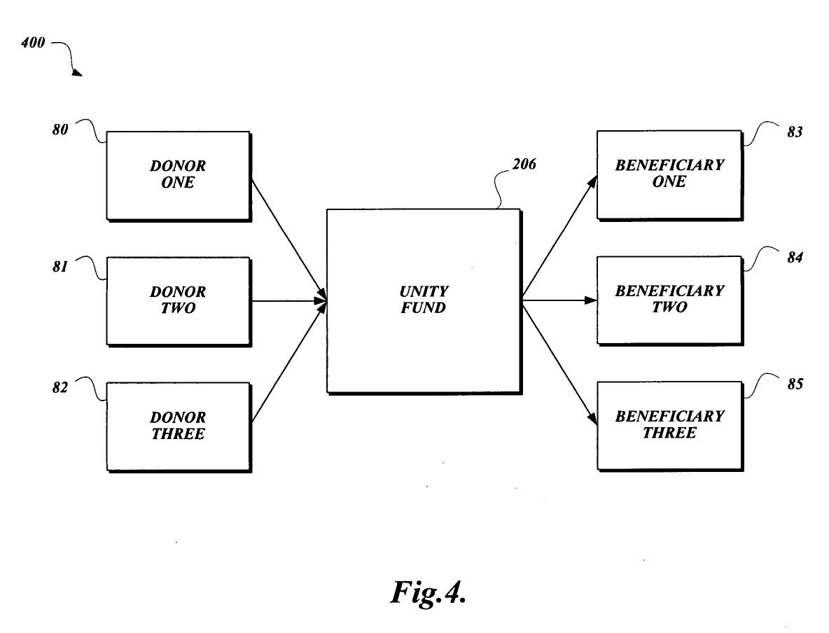

FIG. 4 illustrates aspects of one embodiment of a Unity Fund 206. Unlike a mutual fund, savings and loan institution, or other traditional investment vehicle, the Unity Fund 206 relies on the collective knowledge and goals of the participants to make investment decisions. In this example, three donors—donor one 80, donor two 81, and donor three 82—each made contributions to the donation facilitator 206, part of which were diverted to the Unity Fund 206. Alternatively, one or more of donor one 80, donor two 81, and donor three 82 may contribute directly to the Unity Fund 206. As a result of their donations to the Unity Fund 206, donor one 80, donor two 81, and donor three 82 are given the right to help decide the goals and direction of the investments made by the Unity Fund 206. The amount of power given to each donor may be determined in any one or more of a number of ways, including, but not limited to, by the monetary amount of the donor's contribution and the number of separate contributions made by the donor. Or, the goal and direction of investments may be divided equally among all donors.

One example of investments made by an embodiment of the Unity Fund 206 is shown in FIG. 4 and is similar to traditional lending. In this example, three entities—beneficiary one 83, beneficiary two 84, and beneficiary three 85—apply to the Unity Fund 206 for loans. While it is possible that Unity Fund 206 may make decisions as to whether or not to loan funds to these potential beneficiaries based on conventional criteria such as credit reports, collateral, and the decisions of individual loan officers, it is envisioned that the donors who have contributed to the Unity Fund 206 may instead use their collective knowledge about, and experience with, the potential beneficiaries to decide which loans to approve. In this way, loans may be made available to beneficiaries who are known to the donor community to be trustworthy but who may not have good credit or may otherwise not be able to obtain loans through traditional sources.

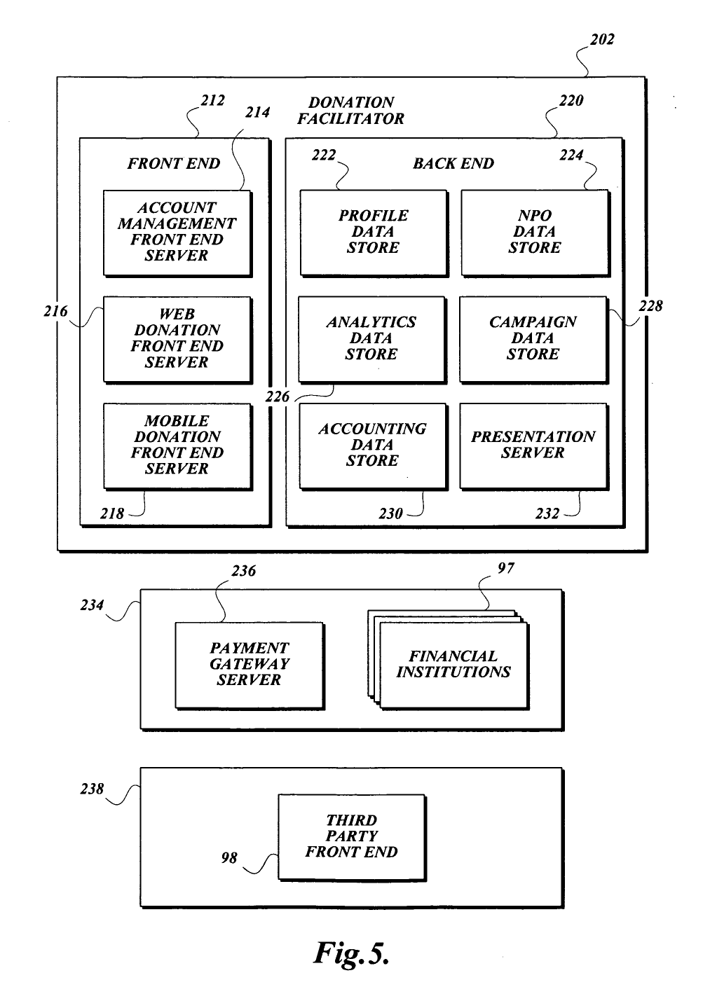

FIG. 5 illustrates one exemplary implementation of a donation facilitator 202. The donation facilitator 202 assists NPOs both in encouraging donations through advertising and social networking, and in providing infrastructure for collecting and storing the donations. The donation facilitator 202 also tracks the donations, which allows the donation facilitator 202 to provide additional ways of rewarding donors for their contributions and encourage repeat donations based on past activity.

The exemplary donation facilitator 202 shown in FIG. 5 comprises a front end 212 and a back end 220. The front end 212 comprises components that allow communication with different types of end user clients and for different types of activities. In one exemplary embodiment, the front end 214 includes an account management front end server 214, which accepts connections from clients to set up accounts with the donation facilitator 202, modify existing accounts, and otherwise perform complex management tasks on accounts. The front end 214 may also include one or more components for providing easy access for a variety of client types to make contributions. For example, the front end 214 may include a web donation front end server 216 and a mobile donation front end server 218. The web donation front end server 216 provides a relatively complex interface that allows a donor to connect using a standard web client, choose a recipient NPO, select a donation amount, and so on. In contrast, the mobile donation front end server 218 provides a relatively simple interface. The simple interface allows a donor to connect with a WAP-enabled device. The simple interface may allow donors to send an Short Message Service (SMS) message indicating a recipient NPO and a donation amount. Thus, the simple interface allows users without access to a smartphone or other rich client device to nevertheless interact with the donation facilitator 202 to make contributions.

The back end 220 includes components that are not accessed directly by client devices, but that instead provide storage or processing to enable the functionality of the donation facilitator 202. The profile data store 222 of the back end 220 contains information associated with a given donor. When a potential donor creates an account with the donation facilitator 202, an account record is created in the profile data store 222. The record includes a login name and a password that controls access to the account. Donor records may also include information identifying the donor and providing donor contact information, such as the donor's name, email address, mobile phone number, and so on. In addition to the login and identification information, the profile data store 222 may store one or more multimedia files associated with the donor, the uses of which are discussed below.

The back end 220 also includes components for keeping track of the donations and funds deposited in the donation facilitator 202. These may include an accounting data store 230 and an analytics data store 226. The accounting data store 230 contains records for each account of the donation facilitator 202, including records of deposits, donations, and current balances. For each donation, the accounting data store 230 may store not only information identifying the target NPO, the date and time, and the amount of the donation, but also information associated with the donation, such as the name of a person or entity to which the donation is to be attributed, one or more multimedia files associated with the donation, a campaign associated with the donation, or one or more persons or entities to be notified of the donation. The data stored by the accounting data store 230 may be used at the end of the year to create reports for each donor summarizing the donor's charitable contributions for the year, which the donor can use for purposes such as budgeting and tax reporting. The analytics data store 226 stores other data concerning the donation and/or the donor, such as donation history, other target NPOs that the donor might be willing to donate to given the donor's past donation history, information for forecasting future donation activity, and the like.

The back end 220 also stores information concerning NPOs. To receive donations via the donation facilitator 202, an NPO must first create an account. Information associated with the NPO account, such as a login and password, the name of the NPO, contact information, information describing the NPO, and so on, are stored by the back end 220 in an NPO data store 224.

Beyond merely creating an account, an NPO can use the donation facilitator 202 to create marketing campaigns, including targeted emails to previous or likely donors, advertising copy or images, the dates, times, and locations at which to show particular ads, and the like. Information concerning these campaigns is stored in a component of the back end 220 identified in FIG. 5 as a campaign data store 228. The marketing campaigns may be further aided by the donation facilitator 202, in that the donation facilitator 202 may be responsible for generating or otherwise causing multimedia presentations related to the campaigns to be displayed. In those cases, a presentation server 232 included in the back end 220 helps to create, transmit, or otherwise display multimedia content to encourage or incentivize the making of donations.

While the accounting data store 230 keeps track of each transaction so that the donation facilitator 202 can perform future processing on the transaction records, in the exemplary embodiment shown in FIG. 5, the actual transfer of funds from an account of the donor to their associated account in the donation facilitator 202 is performed by a separate financial component 234. While the financial component 234 may be completely separate from the donation facilitator 202, one or more elements of the financial components 234 may be a part of the donation facilitator 202. Regardless, in one exemplary embodiment, a payment gateway server 236 acts as an intermediary between the donation facilitator 202 and the financial institutions 97 (such as banks, credit card companies, and the like) at which the donors keep their personal funds. As stated above, the payment gateway server 236 might be a part of the donation facilitator 202, or it may be a separate Automated Clearing House, the web-based front end to a credit card payment system, a common web payment facilitator such as Paypal™, and the like.

In some embodiments, third parties 238 that wish to integrate with or otherwise support the donation facilitator 202 may provide their own third party front end 98 that integrates with components of the donation facilitator 202. Such third party front ends can be used to let potential donors sign up for accounts with the donation facilitator 202 or to direct donations within the donation facilitator 202. A more detailed discussion of integration between the donation facilitator 202 and third party sites is set forth below.

Embodiments of the donation facilitator 202 may be designed to minimize the effort to create an account. Such effort minimization is intended to help increase the number of potential donors that sign up for accounts and, thereby, increase the number of donors who actually contribute to NPOs. One way to reduce the complexity of creating an account is to allow a potential donor to create an account as part of an occurring point of sale transaction. For example, if a potential donor is purchasing tickets to a concert through a web site and the performers want to draw attention to a particular NPO through the donation facilitator 202, the ticket-selling web site may add an option to the checkout process that allows the ticket-purchasing potential donor to create an account at the donation facilitator 202 by simply agreeing to do so. The ticket-selling web site can then send information that the potential donor entered during the point-of-sale transaction (including billing account info, mailing address, email address, and the like) to the donation facilitator 202. This avoids the need for the potential donor to separately enter such data.

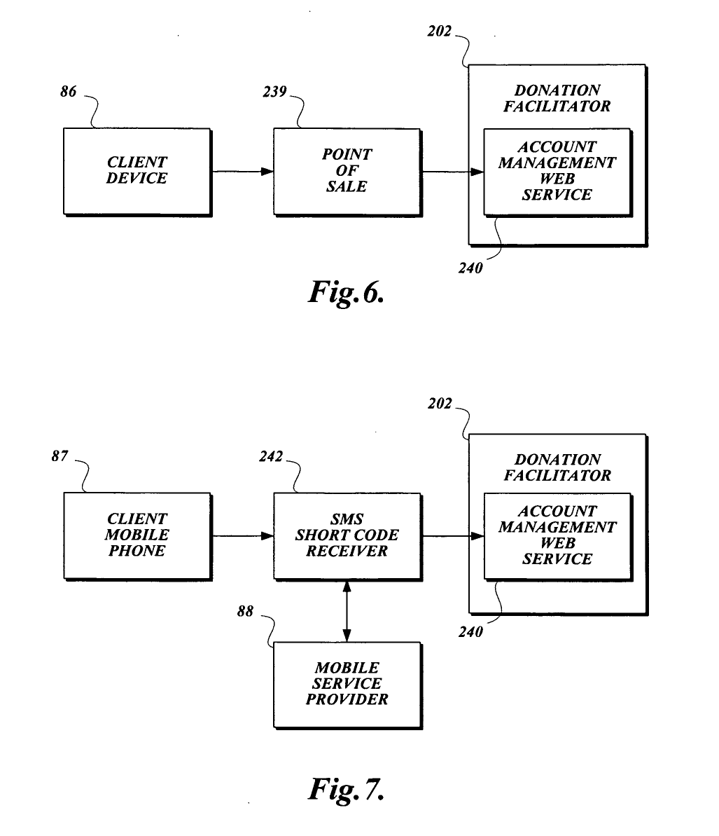

FIG. 6 illustrates an embodiment of selected components of a system that allows a potential donor to open an account with the donation facilitator 202 via a point of sale 239. The potential donor uses a client device 86 to connect to a point of sale 239. In an exemplary embodiment, the point of sale 239 is a web site, terminal, server, or other device that accepts orders from consumers for products offered for sale. The client device 86 may be any device or system supported by the point of sale 239, such as a personal computer or laptop running a web browser, a smartphone running a web browser or a proprietary application designed for the point of sale 239, a mobile device executing a WAP browser, a checkout terminal at a physical store, and the like. The point of sale 239 connects to the account management front end server 214 of the donation facilitator 202 in order to create the account. In the exemplary embodiment illustrated in FIG. 6, the point of sale 239 connects to an account management web service 240 running on the account management front end server 214. However, it is to be understood that other communication techniques between the point of sale 239 and the account management front end server 214 may also be used.

Another way of minimizing the input needed for a donor to interact with the donation facilitator 202 in a variety of environments is to allow the donor to contribute funds to their account with the donation facilitator 202 via an SMS message. FIG. 7 illustrates selected components of an exemplary system that allows a donor who has already established an account at the donation facilitator 202 to add funds to their account via an SMS message. In this example, the donor sends an SMS message from their client mobile phone 87 to an SMS short code receiver 242. An SMS short code is an addressing scheme that allows an SMS message to be sent to a shortened phone number, and to subsequently charge the sender a predetermined amount through their mobile phone bill. As shown, the SMS short code receiver 242 communicates with a mobile service provider 88 to instruct the mobile service provider 88 to charge the phone bill of the message sender an amount, and to transfer those funds to the donation facilitator 202. The amount to be transferred may be a predetermined amount, or it may be specified in the SMS message sent from the client mobile phone 87. The SMS short code receiver 242 communicates with the account management web service 240 to add the appropriate amount to the donor's account with the donation facilitator 202. While SMS is illustrated and described, other embodiments may use similar mobile technologies, such as MMS.

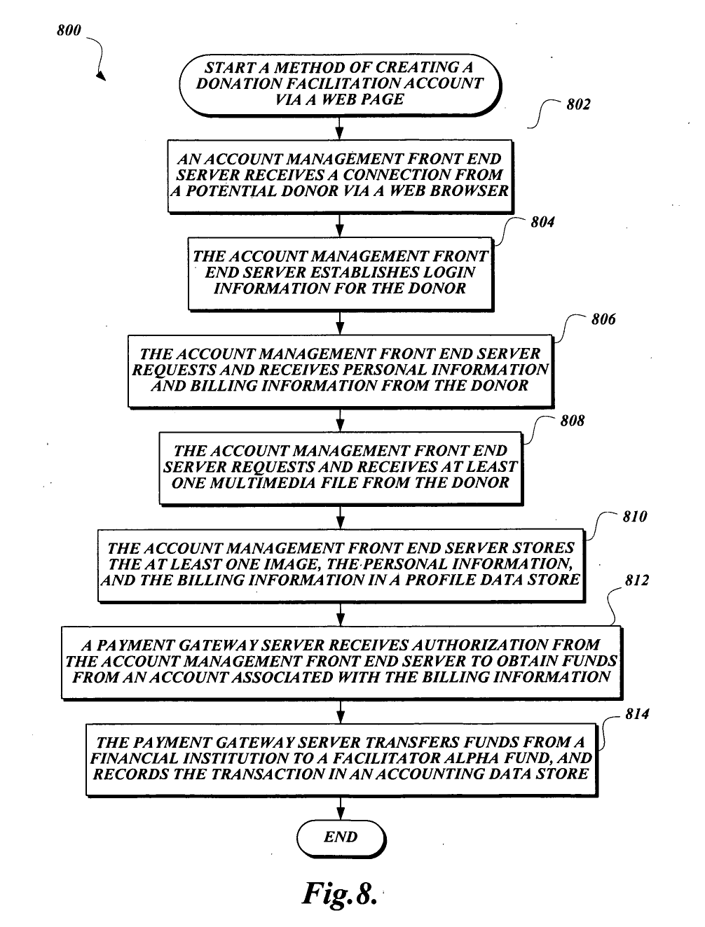

FIG. 8 illustrates an exemplary method 800 of creating a donation facilitation account via a web page. Such a web page may be displayed by the account management front end server 214 of the donation facilitator 202. From a start block, the method 800 proceeds to block 802, where an account management front end server 214 receives a connection from a potential donor via a web browser. Next, at block 804, the account management front end server 214 establishes login information for the donor. The account management front end server 214 may, for example, generate a prompt for the donor to create a login name and password. Obviously, other methods may be employed to establish login information, such as automatically generating a login name and password, for example. The method 800 then proceeds to block 806, where the account management front end server 214 requests and receives personal information and billing information from the donor. As described above, the personal information may comprise a first name, a last name, a mailing address, an email address, a mobile phone number, and the like. The billing information may comprise information usable to access an account at a financial institution 97, such as a bank account number, a credit card number and expiration date, and the like. Next, at block 808, the account management front end server 214 requests and receives at least one multimedia file from the donor.

The method 800 then proceeds to block 810, where the account management front end server 214 stores the at least one multimedia file, the personal information, and the billing information in the profile data store 222. Next, at block 812, a payment gateway server 236 receives authorization from the account management front end server 214 to obtain funds from an account associated with the billing information. The method 800 then proceeds to block 814, where the payment gateway server 236 transfers funds from a financial institution 97 to a facilitator alpha fund 204, and records the transaction in an accounting data store 230. The method 800 then continues to an end block and terminates.

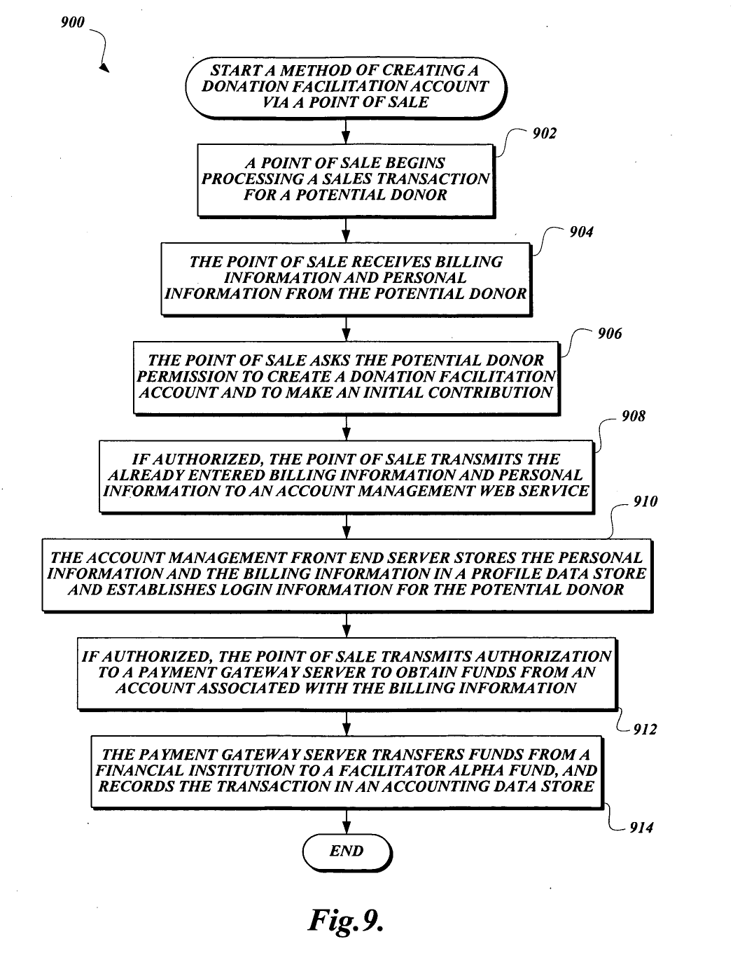

FIG. 9 illustrates one embodiment of a method 900 of creating a donation facilitation account via a point of sale 239. From a start block, the method 900 proceeds to block 902, where a point of sale 239 begins processing a sales transaction for a potential donor. Next, at block 904, the point of sale 239 receives billing information and personal information from the potential donor. This billing information and personal information is substantially similar to the billing information and personal information described above, but may contain more or less items of information depending on the requirements of the particular point of sale.

The method 900 then proceeds to block 906, where the point of sale 239 asks the potential donor permission to create a donation facilitation account and to make an initial contribution. Asking the potential donor for an initial contribution at a point of sale may be particularly effective in encouraging submission of funds to the donation facilitator 202, as the potential donor is already releasing billing information and is already spending money on the point of sale transaction. Next, at block 908, if authorized, the point of sale 239 transmits the already entered billing information and personal information to an account management web service 240.

The method 900 then proceeds to block 910, where the account management front end server 214 stores the personal information and the billing information in a profile data store 222 and establishes login information for the potential donor. Next, at block 912, if authorized, the point of sale 239 transmits authorization to a payment gateway server 236 to obtain funds from an account associated with the billing information. The method 900 then proceeds to block 914, where, the payment gateway server 236 transfers funds from a financial institution 97 to a facilitator alpha fund 204, and records the transaction in an accounting data store 230. The method 900 then continues to an end block and terminates.

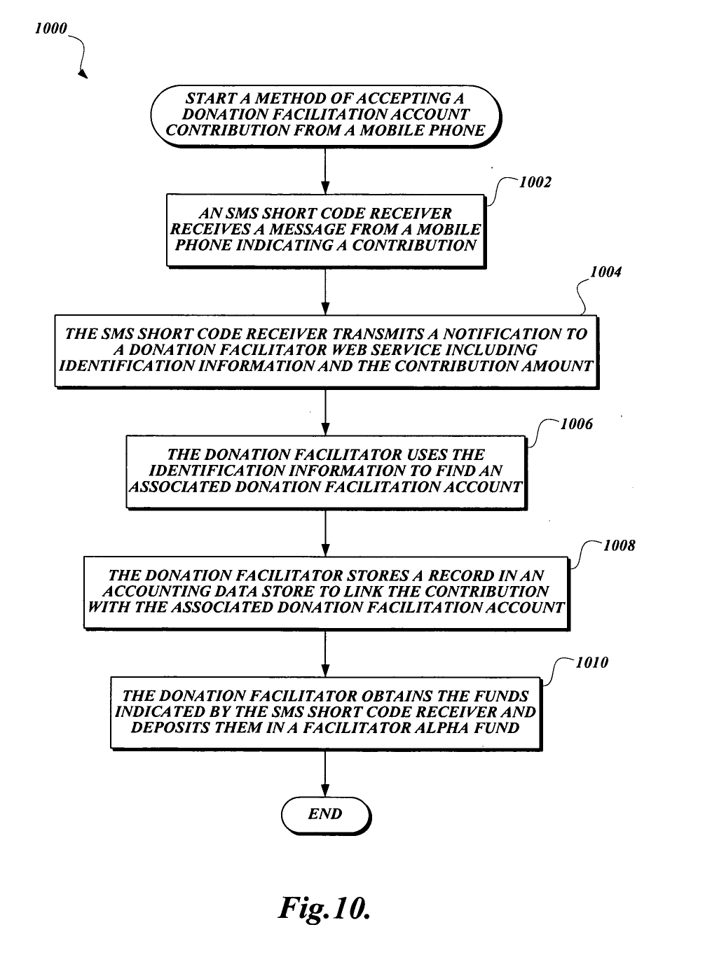

FIG. 10 illustrates one embodiment of a method 1000 of accepting a donation facilitation account contribution from a mobile phone 87. From a start block, the method 1000 proceeds to block 1002, where an SMS short code receiver 242 receives a message from a mobile phone 87 indicating a contribution. The message may include a user-specified amount to contribute, and may include an identification of an NPO to receive the contribution. For example, the contribution amount or NPO may be predetermined based on the SMS short code. Alternatively, the contribution may not be directed to a particular NPO, but instead directed to the donor's account at the donation facilitator 202 for holding until the donor takes further action to assign it to a particular NPO.

Next, at block 1004, the SMS short code receiver 242 transmits a notification to an account management web service 240. The notification includes the identification information and the contribution amount. The method 1000 then proceeds to block 1006, where the donation facilitator 202 uses the identification information to find an associated donation facilitation account. For example, the identification information may include the mobile phone number from which the SMS message was sent, which has been stored in the profile data store 222 during account creation. In this way, the donation facilitator 202 can associate the contribution with the proper account even though the donor did not include any identification information in the SMS message. Next, at block 1008, the donation facilitator 202 stores a record in an accounting data store 230 that links the contribution with the associated donation facilitation account. The method 1000 then proceeds to block 1010, where the donation facilitator 202 obtains the funds indicated by the SMS short code handler 242, and deposits them in a facilitator alpha fund 204. The method 1000 then terminates.

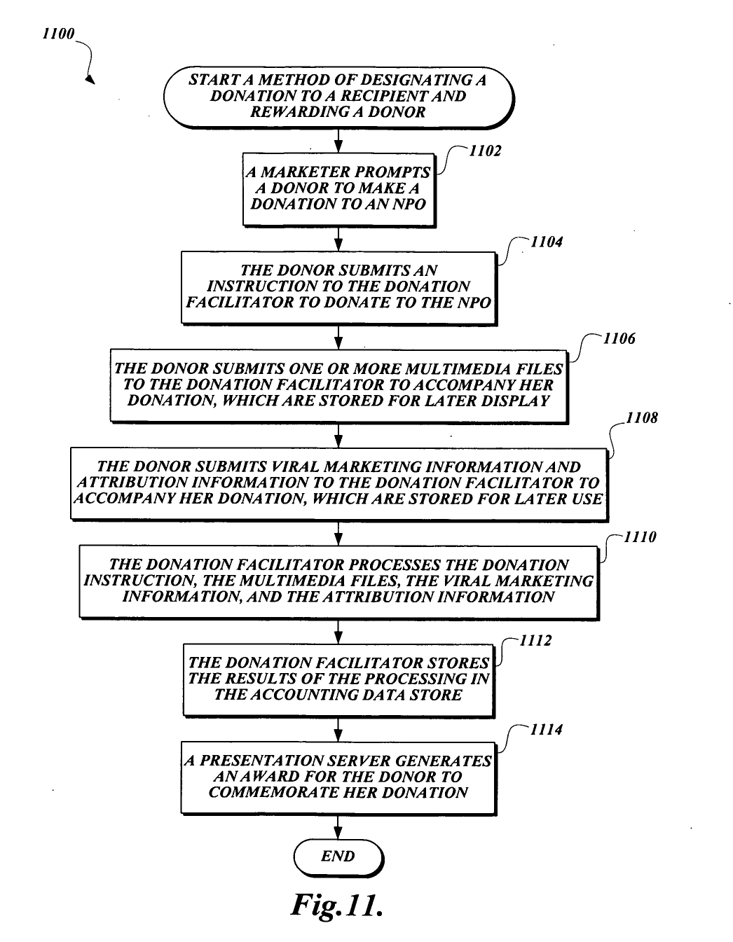

FIG. 11 illustrates an exemplary method 1100 of designating a donation to a recipient and rewarding a donor. This method 1100 assumes that a donor has established an account with the donation facilitator 202, and has contributed general funds to her account. In this method 1100, these funds are held in a facilitator alpha fund 204 until directed to a recipient NPO by the donor. However, it is also contemplated that the donor could add funds to an account and direct those funds to a recipient NPO at the same time.

From a start block, the method 1100 proceeds to block 1102, where a marketer prompts a donor to make a donation to an NPO. This prompt could take place in any of a number of ways, such as through an interactive web advertisement or a print advertisement. In one particularly effective exemplary embodiment, the marketer is a performer in front of a large crowd, such as a singer in a band at a concert, who implores the audience members to access their accounts at the donation facilitator 202 and to donate to a cause the singer is associated with. In any case, the donation facilitator 202 stores information coordinating the prompt in a campaign data store 228, whether it is a time and target demographic for a web advertising campaign, or a time and script intended to be used by the performer.

Next, in block 1104, the donor submits an instruction to the donation facilitator 202 to donate to the NPO, in response to the prompt. This submission may be made via any client device available to the donor and supported by the donation facilitator 202, such as a mobile phone or a smartphone capable of running a web browser. In an embodiment where the donor uses a smartphone or other web browser, the donor connects to a web donation front end server 216. In an embodiment where the donor uses a mobile phone, the donor connects to a mobile donation front end server 218.

The instruction to the donation facilitator 202 may contain an identification of the NPO and the amount of the donation. Alternatively, the amount of the donation may be predetermined by an amount associated with an address to which the instruction is sent. In one embodiment, the instruction does not contain an identification of the NPO. Instead, the donation facilitator 202 uses other information at its disposal to determine what prompt the donor was likely to have been exposed to.

For example, the campaign data store 228 may contain information listing only one campaign that is active on a given day, and may contain information intended to cause a prompt to be displayed at 8:00 PM on that day. Thus, the donation facilitator 202 may assume that donations received shortly after 8:00 PM on that day that do not designate a different NPO are intended for the NPO associated with the active campaign, and may route the donations accordingly.

As another example, the campaign data store 228 may contain location information concerning where the prompt is to be delivered (such as at a particular sports venue). If the instruction contains an indication of where the donor is located at the time of the donation, such as GPS data from a smartphone or an IP address from a network connection, the donation facilitator 202 may assume that a donor at the location where the prompt is to be delivered intended to donate to the associated NPO, and route that donation accordingly as well.

Next, the method 1100 proceeds to block 1106, where the donor submits one or more multimedia files to the donation facilitator 202 to accompany her donation, which are stored for later display. In one embodiment, the donor does not submit any additional multimedia files, but the donation facilitator 202 simply uses one or more multimedia files that were submitted at the time the account was created. Next, in block 1108, the donor submits viral marketing information and attribution information to the donation facilitator 202 to accompany her donation, which are stored for later use. The later use of the one or more multimedia files, the viral marketing information, and attribution information will be discussed in further detail below.

The method 1100 then proceeds to block 1110, where the donation facilitator 202 processes the donation instruction, the multimedia files, the viral marketing information, and the attribution information. Next, at block 1112, the donation facilitator 202 stores the results of the processing in the accounting data store 230. The method 1100 then proceeds to block 1112, where a presentation server 232 generates an award for the donor to commemorate her donation.

As mentioned above, embodiments of the donation facilitator 202 allow donors to submit one or more multimedia files, either while creating their account or accompanying a donation. As also mentioned above, embodiments of the donation facilitator 202 generate awards for donors to commemorate their donations. In some embodiments, the donation facilitator 202 uses the submitted multimedia files in the generation of awards. For example, a donor may take a picture of himself or herself at a concert with the camera on his or her smartphone. Then, when making a donation with his or her smartphone at the concert, he or she uploads the picture from the concert. This uploading may take place over an internet connection of the phone, an MMS message to an appropriate gateway, or any other method of transmitting a multimedia file from a mobile device. The presentation server 232 may generate a multimedia file representing the concert, such as a picture or video of a band performing on stage. The presentation server 232 may then combine the uploaded picture from the donor with the picture of the band performing on stage, and then email the combined picture to the donor. The presentation server 232 may make the reward picture available in other ways as well, such as by allowing the donor to download the combined picture from the donation facilitator 202, allowing the donor to post the combined picture to a social networking profile, and the like. In some embodiments, the presentation server 232 applies watermarking or other digital rights management techniques to the generated multimedia file to reassure viewers of the multimedia file that it was created by the donation facilitator 202 as a result of a donation. Also, in some embodiments, the multimedia files uploaded by the donor may be video files, and the multimedia files generated by the presentation server 232 may contain videos from donors instead of just static images.

In one exemplary embodiment, the presentation server 232 may create combined images to commemorate all of the donations made associated with a given event or campaign. The creation of a combined image can help to generate even more donations, as attendees at the given event will want to take part in the shared experience. For example, when creating a campaign, an NPO may specify a master image, such as the NPO's logo, an artistic pattern, or the like. The master image may contain the pattern, but the pattern will otherwise be blank or empty. As donations associated with the campaign are made, the presentation server 232 takes the uploaded multimedia files and uses them to fill in the pattern in the master image. In this way, the individual multimedia files are combined to form the pattern in the master image, and each donor can recognize that their multimedia files have been incorporated into the pattern.

In one exemplary embodiment, the presentation server 232 may also create a global image that commemorates all of the donations made via the donation facilitator 202, regardless of the associated campaign or NPO. For example, the donation facilitator 202 may store the pattern of an image with a predetermined number of pixels. Each time a donor transfers a predetermined unit of money to the donation facilitator 202, the presentation server 232 causes a pixel of the pattern to be filled in. In a particular example, the donation facilitator 202 may store a mandala pattern containing one pixel for every person on earth (or 6.5 billion pixels), and the presentation server 232 fills in a pixel of the mandala for each dollar that is donated through the donation facilitator 202, eventually completing the mandala pattern once $6.5 billion has been donated through the donation facilitator 202. This mandala pattern is intended to drive further contributions until the global fundraising goal of one dollar for every person on Earth is achieved. In yet another exemplary embodiment, similar goal images can be created for individual NPOs. These goal images are intended to track progress toward a fundraising goal using the particular iconography of the NPO by filling in an image associated with the NPO in the same pixel-by-pixel manner.

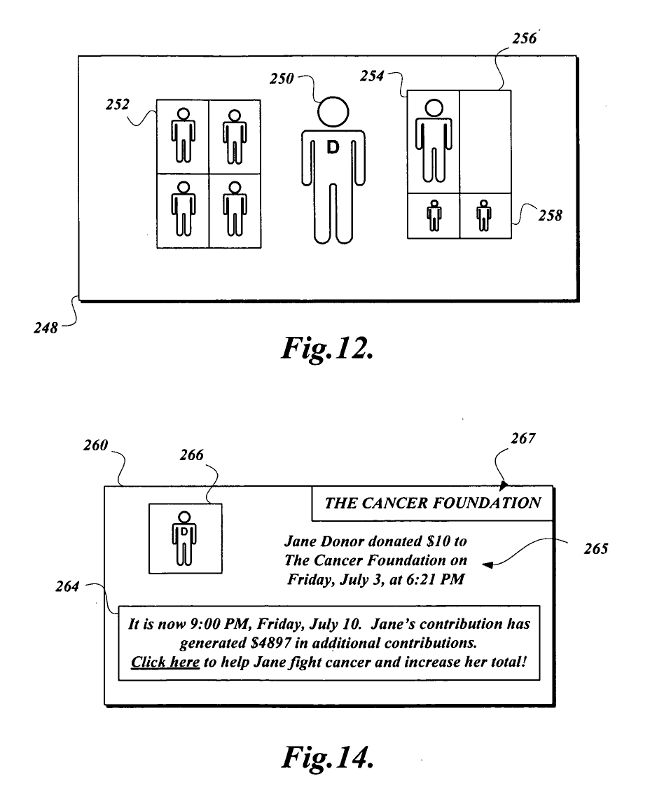

FIG. 12 illustrates some aspects of the images generated by the presentation server 232. As illustrated, the master image 248 contains patterns formed by multiple donors. This master image 248 may have been specially generated for a donor “D,” whose submitted image 250 is given a prominent place in the master image 248. Images from other donors may be used to fill in the rest of a pattern in the master image 248. For instance, images may be evenly distributed throughout a pattern 252. As another example, images may be resized to reflect the relative size of donations. Image 254 is resized to be large to correspond to a larger donation submitted by the associated donor, and image 258 is resized to be smaller to correspond to a smaller donation submitted by another donor. The sizing of the images is intended to incentivize donors to make larger contributions, so that their multimedia file ends up being displayed more prominently. Further, empty portions 256 may be displayed in the pattern. The empty portions are intended to incentivize individuals who have not previously donated to contribute, and have their multimedia file fill parts of the empty space.

While embodiments in which one multimedia file accompanies each donation and is displayed in the master image 248 have been described, multiple multimedia files may accompany a given donation. In one exemplary embodiment, the donation facilitator 202 may allow the upload of one multimedia file for each level of donation. For example, the donation facilitator 202 may allow one multimedia file to be uploaded for every $10 donated. This control is intended to incentivize donors to give larger amounts, so that more than one of the donor's multimedia files are included in the master image 248.

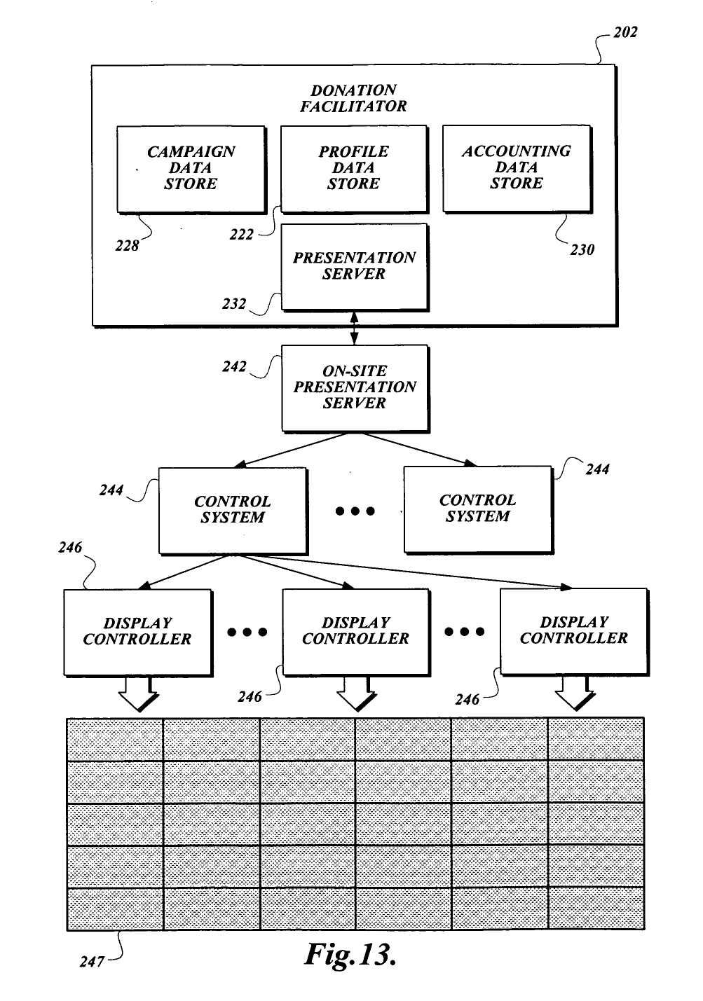

A particularly effective way to both solicit donations and to incentivize donations is to prompt for donations at a large event, such as at a concert or sporting event. The venues for such events often have large-format video screens, such as a jumbotron. FIG. 13 illustrates one exemplary embodiment of a system configured to display a master image 248 on such a large-format video screen during an event in real time. The presentation server 232 retrieves information from the campaign data store 228 to determine when and what to display as a master image 248 associated with a campaign. The presentation server 232 then retrieves information from the accounting data store 230 to determine the number and size of donations that have been made that are associated with the campaign, and retrieves the associated multimedia files from the profile data store 222. Once the data for the master image 248 is gathered, the presentation server 232 transmits the data to an on-site presentation server 242 at the event venue. While the on-site presentation server 242 is not necessary, having such a server located at the event venue may increase the reliability and availability of the display of the master image 248.

The on-site presentation server 242 receives the information defining the elements of the master image 248 from the presentation server 232, including time to display the master image 248, the overall pattern, the individual component multimedia files, and the like. The on-site presentation server 242 may also receive input from other sources. For example, a user input terminal may allow an operator to manually control the on-site presentation server 242. As another example, in an embodiment where the on-site presentation server 242 is located at a concert venue, the on-site presentation server 242 may integrate with the rest of the production equipment, including controls for the concert lighting and sound. In this embodiment, the on-site presentation server 242 may be able to alter the display of the master image 248 in response to the music being played or in response to other performance cues. For example, the on-site presentation server 242 may add individual multimedia files to the master image 248 in time with the music, or may cause the overall image to pulsate in time with the music being played.

In some embodiments, the video display 247 is a large composite display, made up of multiple individual displays. Once the on-site presentation server 242 has prepared the master image 248 for display, the on-site presentation server 242 instructs one or more control systems 244 to display the master image 248. Each control system 244 is connected to one or more display controllers 246, which in turn each control one or more portions of the video display 247. In this way, the on-site presentation server 242 may coordinate each of the individual portions of the video display 247 to display the composite master image 248 in real time, and may also add new donor images to the composite master image 248 in real time to incentivize further giving at the venue.

In some embodiments, images and information from multiple campaigns can be combined into a single master image 248. For example, in one embodiment, a donation facilitator 202 creates one overall master image 248, which contains a very large number of empty spaces for donor images and which is filled with donor images from every donation made through the donation facilitator 202. In this way, the overall master image 248 can be used to promote the donation facilitator 202 itself, and to again drive further donation and account creation.

Social networking is another way in which additional donations can be encouraged. In one exemplary embodiment, when a donor submits a donation, the donor may also submit a name, contact information, and/or a photo of a third party on whose behalf the donor is making the donation. In this case, the donation facilitator 202 may store this information in the accounting data store 230, and may contact the third party to inform them that the donation has been made. The intention of the contact is to encourage the third party to create their own account with the donation facilitator 202. In another exemplary embodiment, the donor may make the donation on their own behalf, but may also submit the names and contact information of a plurality of third parties to notify about the donation. Again, the intention is to encourage the third parties to make additional donations or open accounts with the donation facilitator 202.

FIG. 14 illustrates an additional aspect of the social networking features of one exemplary embodiment of the donation facilitator 202. The presentation server 232 may provide information that enables display of a profile box 260 associated with a particular donation and donor. The profile box 260 may contain a multimedia file 266 uploaded along with the donation to help identify the donor and the event. The profile box 260 may identify the NPO receiving the donation 267, and may include details about the donation itself 265. The social networking aspect shows the effectiveness of the donor's efforts to get other individuals to contribute. More specifically, the profile box 260 displays a summary 264 of all other donations that have been made that are related to the donor's original donation. The summary is obtained by the presentation server 232 querying the accounting data store 30 to determine each donation that was made after receiving a notification of the donor's original donation, donations that were made after receiving a notification of those donations, and so on. The presentation server 232 may also query the accounting data store 30 to determine if any challenge grant donations were added to the total donations made to the NPO. The presentation server 232 then adds all of the totals to enable the summary 264 showing the overall contribution associated with the original donor. This display is intended to incentivize further donations from the original donor by making the donor feel that he or she is having an impact that is larger than his or her original donation.

While the embodiments described above generally contemplate a donor undertaking an explicit interaction with the donation facilitator 202 to cause a donation to occur, the streamlined bookkeeping features of the donation facilitation system 200 allow embodiments to support more indirect methods of indicating donations. Once a donor has loaded their account at the donation facilitator 202, very small contributions can be made from of this initial funds transfer to other accounts at the donation facilitator 202 without incurring significant transaction costs. This can allow small, frequent donations to be made, which could be triggered by less explicit activities. This, in turn, can generate a steady stream of preconfigured micro-donations to a given NPO.

In one exemplary embodiment, a donor who has loaded his or her account at the donation facilitator 202 can configure his or her account to transfer a small, predetermined amount to a particular NPO each time a specified event occurs. As one example, a donor may instruct the donation facilitator 202 to donate one cent to a given NPO every time the donor sends a text message. Upon receiving notification of the text message, the donation facilitator 202 will transfer one cent from the donor's account to the given NPO. As another example, a donor may instruct the donation facilitator 202 to donate five cents to a given NPO each time their favorite soccer team scores a goal. Upon receiving notification of the goal, either via manual entry or via a data feed distributed by the team or league, the donation facilitator 202 can transfer five cents from the donor's account to the NPO. One advantage of using the donation facilitator 202 is that the accounting data store 230 contains a record of each micro-transaction, and donors can track their aggregate giving even when the donations are very small and/or frequent.

While illustrative embodiments have been illustrated and described, it will be appreciated that various changes can be made therein without departing from the spirit and scope of the invention. As a nonlimiting example, the components, servers, and data stores illustrated may reside on the same physical device, or may be spread across multiple devices. As another nonlimiting example, the described functionality of a given component may be contained within a single component, spread across multiple components, or combined with the functionality of other components. The illustrated servers and data stores may be similarly contained within single, multiple, or combined servers and data stores. As yet another nonlimiting example, the components, servers, and data stores are contemplated to be implemented with computer hardware that is well-known in the art to include at least some components such as internal and external storage devices, one or more processors, memory, removable storage media, display devices, input devices, network connections, and so on. Where portions of embodiments of the disclosed methods are implemented as computer-executable instructions, these instructions may be stored on a tangible computer-readable medium and, if executed, cause one or more processors of a computer system to perform the disclosed methods.

The embodiments of the invention in which an exclusive property or privilege is claimed are defined as follows:

1. A system for encouraging and facilitating donations, the system comprising:
a profile data store;
an account management front end server configured to enable creation of accounts and to store account data within the profile data store;
a donation front end server configured to receive donations associated with accounts and one or more multimedia files associated with each donation; and
a presentation server configured to generate multimedia output based on the one or more multimedia files associated with each donation.

2. The system of claim 1, wherein the presentation server is coupled to an on-site presentation server, and wherein the presentation server is configured to transmit the generated multimedia output to the on-site presentation server.

3. The system of claim 2, wherein the presentation server is configured to transmit the generated multimedia output to the on-site presentation server for display on a large-format video screen.

4. The system of claim 1, wherein the multimedia output comprises a video stream that includes a combination of two or more multimedia files associated with donations.

5. The system of claim 1, further comprising a campaign data store configured to store a pattern into which the presentation server is configured to arrange the one or more multimedia files.

6. The system of claim 1, further comprising an accounting data store configured to store an indication of which multimedia files the presentation server should include while generating multimedia output.

7. The system of claim 1, wherein the donation front end server is a web donation front end server configured to receive donations from donors via web browsers.

8. The system of claim 1, wherein the donation front end server is a mobile donation front end server configured to receive donations from donors via mobile devices.

9. A method of accepting a donation and rewarding a donor, the method comprising, under the control of instructions executed by one or more processors of a computer system:
transmitting an indication that causes a prompt to be presented, wherein the prompt instructs one or more potential donors to submit a donation;
receiving a donation notification and an associated multimedia file from a donor;
generating a reward multimedia presentation including at least the associated multimedia file from the donor, and
presenting the reward multimedia presentation to the donor.

10. The method of claim 9, further comprising withdrawing funds from a third party financial institution according to an indication in the donation notification.

11. The method of claim 9, further comprising transferring funds from an account associated with the donor to an account associated with an organization indicated by the donation notification.

12. The method of claim 11, wherein the donation notification includes an indication of a date and time at which the donation notification was transmitted; and wherein the method further comprises determining the organization indicated by the donation notification by querying a campaign data store for a campaign taking place at the date and time at which the donation notification was transmitted.

13. The method of claim 12, wherein the donation notification includes an indication of a geographic location from which the donation notification was transmitted; and wherein determining the organization indicated by the donation notification further comprises querying a campaign data store for a campaign taking place at the geographic location from which the donation notification was transmitted at the date and time at which the donation notification was transmitted.

14. The method of claim 9, wherein the reward multimedia presentation includes the associated multimedia file from the donor and multimedia files from other donors who have contributed to an organization indicated by the donation notification.

15. The method of claim 9, wherein presenting the reward multimedia presentation comprises displaying the reward multimedia presentation on a large-format video screen.

16. The method of claim 15, wherein displaying the reward multimedia presentation on a large-format video screen comprises adding the associated multimedia file from the donor to an already displayed image on the large-format video screen in real time.

17. A computer-implemented method of creating an account at a donation facilitation system, the method comprising:
receiving, by an account management front end server, a notification from a point of sale that a potential donor has consented to creation of an account, wherein the notification includes billing information and personal information associated with the potential donor that were entered as part of the point of sale transaction;
storing the personal information and the billing information in a profile data store;
establishing login information associated with the potential donor; and
transmitting the login information to the potential donor via the point of sale.

18. The method of claim 17, further comprising:
receiving authorization to obtain funds from an account at a financial institution associated with the billing information; and
obtaining the funds from the account.

19. The method of claim 17, further comprising:
receiving an SMS message indicating a contribution, the SMS message including at least a sending mobile phone number;
determining an associated account at the donation facilitation system based on the sending mobile phone number; and
storing an indication in an accounting data store to link the contribution with the associated account at the donation facilitation system.

20. The method of claim 19, further comprising:
obtaining funds indicated by the SMS message from a mobile service provider associated with the sending mobile phone number.
